(19) United States
(12) Patent Application Publication
(10) Pub. No.: US 2020/0408999 A1
(43) Pub. Date: Dec. 31, 2020

(54) BACKPLANE AND SLED CONNECTOR ASSEMBLY

(71) Applicant: Molex, LLC, Lisle, IL (US)

(72) Inventors: Richard CHADBOURNE, Lisle, IL (US); Wenzong CHEN, Naperville, IL (US); Rob WHEELER, Lombard, IL (US)

(73) Assignee: Molex, LLC, Lisle, IL (US)

(21) Appl. No.: 16/971,687

(22) PCT Filed: Mar. 11, 2019
(86) PCT No.: PCT/IB2019/051966

§ 371 Date: Aug. 21, 2020

Related U.S. Application Data
(60) Provisional application No. 62/641,070, filed on Mar. 9, 2018.

(51) Int. Cl. G02B 6/38; H01R 13/74; H01R 13/627

(52) U.S. Cl. CPC G02B 6/3897; H01R 13/6272; H01R 13/743

(57) ABSTRACT

A backplane and sled connector assembly includes a backplane connector and a sled connector which are configured to be mated together. The backplane connector is configured to be mounted to a backplane 26 and the sled connector is configured to be mounted to a sled. When the backplane connector, the sled connector, the backplane and the sled are mated together, the backplane and the sled are parallel.

### RELATED APPLICATIONS

This application claims the benefit under 35 U.S.C. § 119(e) of the filing date of U.S. Provisional Patent Application No. 62/641,070, for “BACKPLANE AND SLED CONNECTOR ASSEMBLY” which was filed on Mar. 9, 2018, and which is incorporated here by reference.

### TECHNICAL FIELD

This disclosure relates to the field of connectors, more specifically to a backplane and sled connector assembly.

### DESCRIPTION OF RELATED ART

To connect all nodes of a network to one another, a large number of connections is usually required, which becomes impractical if individual optical fibres are used to make the connections to a backplane. However, due to difficulty in alignment, problems have been encountered in designing an interconnect which provides a consistent and reliable coupling of connectors to the backplane.

### SUMMARY

A backplane and sled connector assembly includes a backplane connector and a sled connector which are configured to be mated together. The backplane connector is configured to be mounted to a backplane 26 and the sled connector is configured to be mounted to a sled. When the backplane connector, the sled connector, the backplane and the sled are mated together, the backplane and the sled are parallel.

### BRIEF DESCRIPTION OF THE DRAWINGS

The present invention is illustrated by way of example and not limited in the accompanying figures in which like reference numerals indicate similar elements and in which:

FIG. 1 is a perspective view of an assembly including a backplane connector and a sled connector according to an example implementation;

FIG. 2 is a perspective view of the assembly including a backplane connector and a sled connector according to an example implementation;

FIG. 3 is a side view of the assembly including a backplane connector and a sled connector according to an example implementation;

FIG. 4 is a side view of the assembly including a backplane connector and a sled connector according to an example implementation;

FIG. 5 is perspective view of a backplane connector according to an example implementation;

FIG. 6 is a side view of a backplane connector according to an example implementation;

FIG. 7 is a side view of a backplane connector according to an example implementation; and

FIG. 8 is a closeup side view of a backplane connector according to an example implementation;

FIG. 9 is a closeup side view of backplane connector according to an example implementation;

FIG. 10 is a side view of a backplane connector according to an example implementation;

FIG. 11 is a side view of a backplane connector according to an example implementation;

FIG. 12 is a perspective view of a sled connector according to an example implementation;

FIG. 13 is an exploded perspective view of a sled connector according to an example implementation;

FIG. 14 is a side view of an outer housing of a sled connector according to an example implementation;

FIG. 15 is a side view of an outer housing of a sled connector according to an example implementation;

FIG. 16 is a side view of an outer housing of a sled connector according to an example implementation; and

FIG. 17 is a side view of an outer housing of a sled connector according to an example implementation.

### DETAILED DESCRIPTION

While the disclosure may be susceptible to embodiment in different forms, there is shown in the drawings, and herein will be described in detail, specific embodiments with the understanding that the present disclosure is to be considered an exemplification of the principles of the disclosure, and is not intended to limit the disclosure to that as illustrated and described herein. Therefore, unless otherwise noted, features disclosed herein may be combined together to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

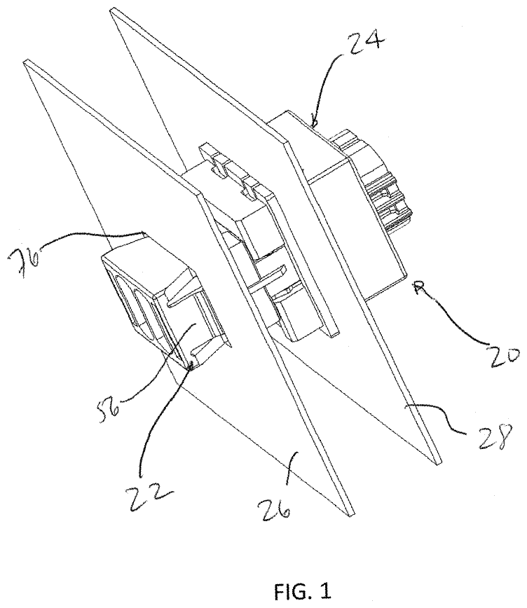

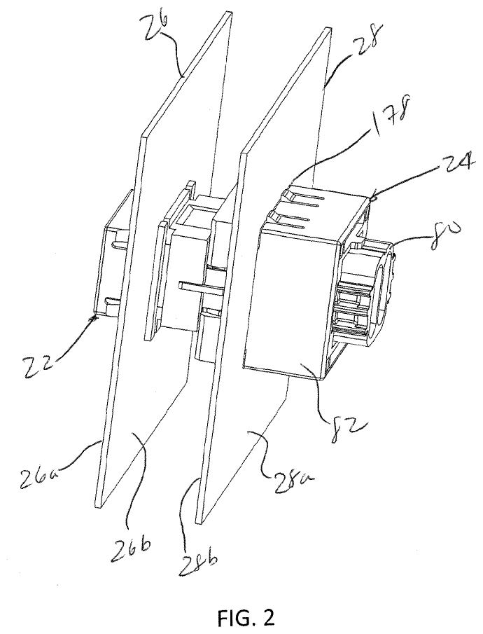

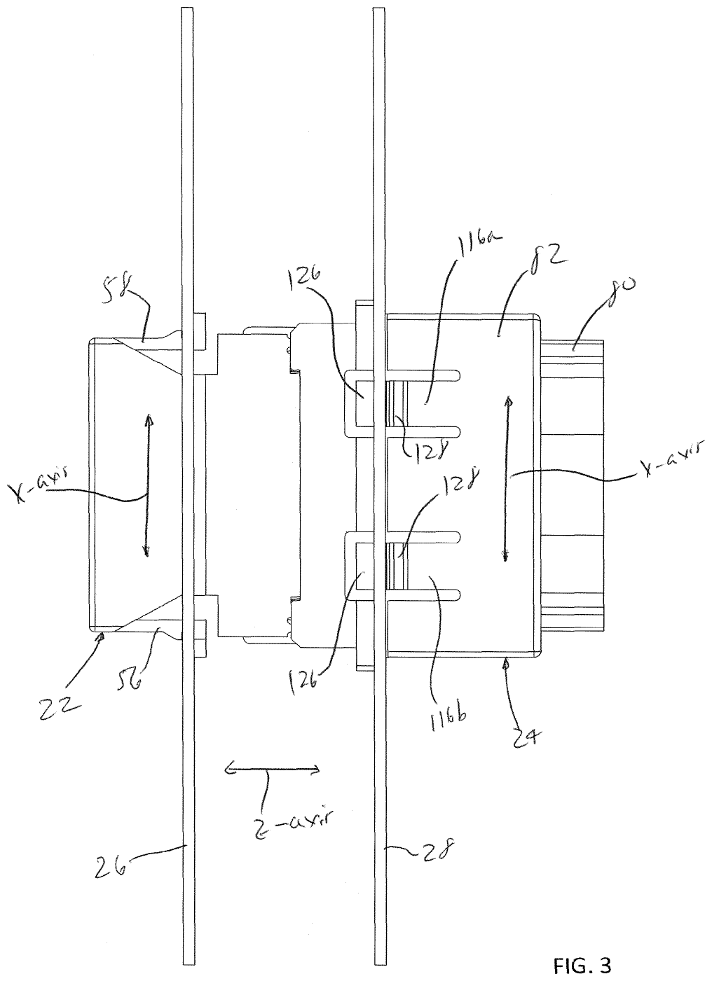

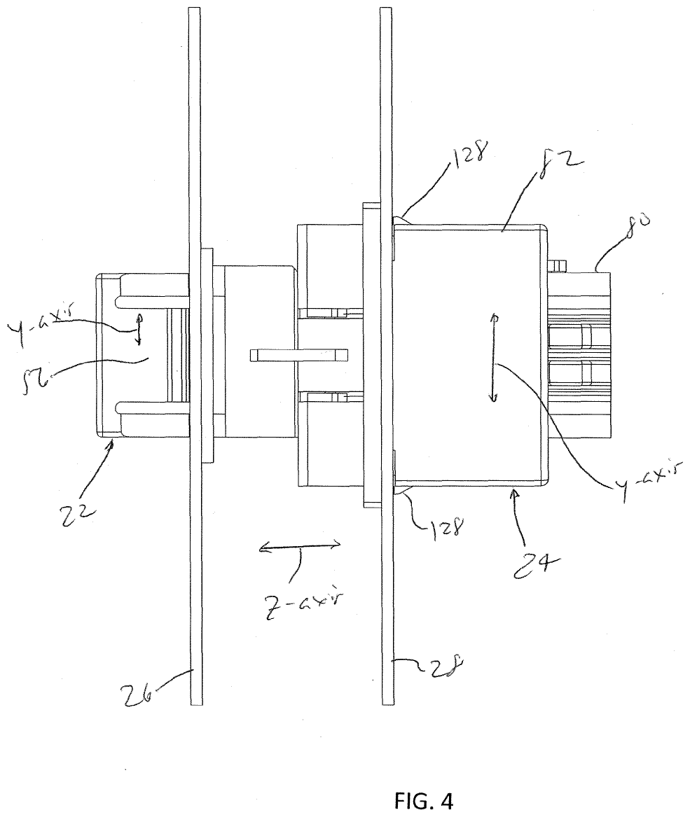

FIGS. 1-4 show an assembly including a backplane connector and a sled connector according to an example implementation. The present disclosure provides a backplane and sled connector assembly 20 which includes a backplane connector 22 and a sled connector 24 which are configured to be mated together. The backplane connector 22 is configured to be mounted to a backplane 26 and the sled connector 24 is configured to be mounted to a sled 28. When the backplane connector 22, the sled connector 24, the backplane 26 and the sled 28 are mated together, the backplane 26 and the sled 28 are parallel. The term “connector” as used herein refers to a device which may be engaged and disengaged repeatedly, often with a different plug or receptacle. Such connectors are known in the art. While directional terms, such as “top” and “bottom” and the like, are used herein, this is only used for convenience in explanation and do not denote a required direction of orientation.

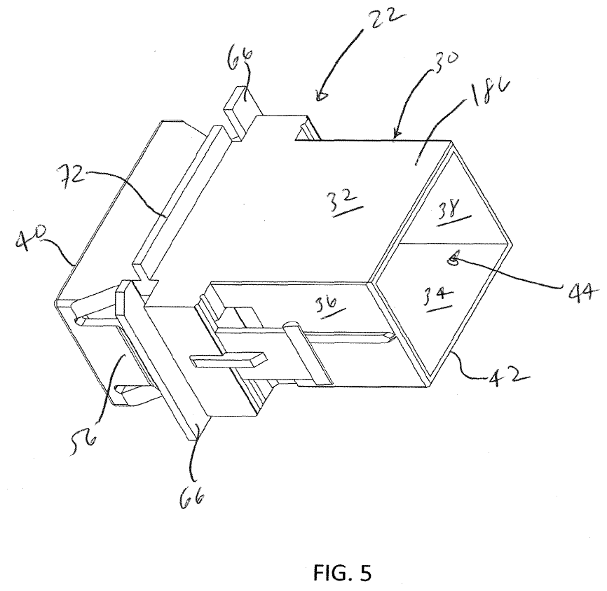

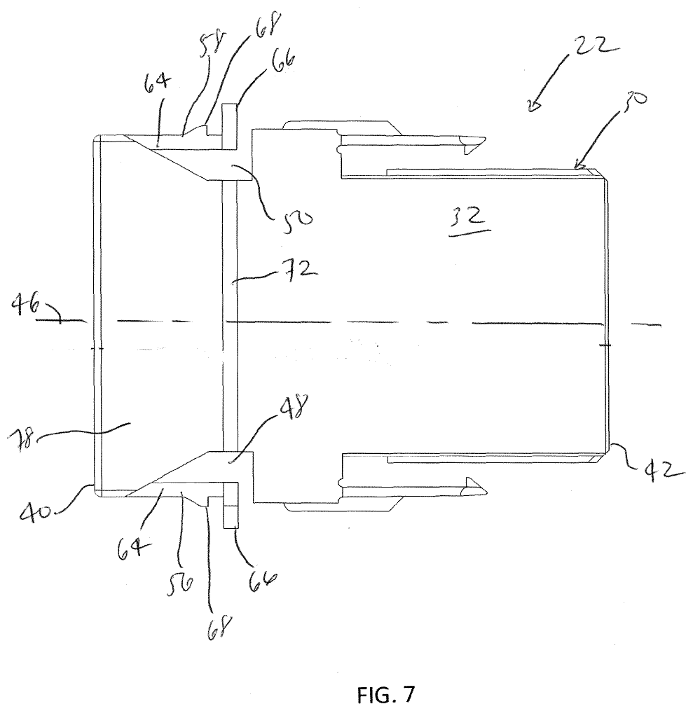

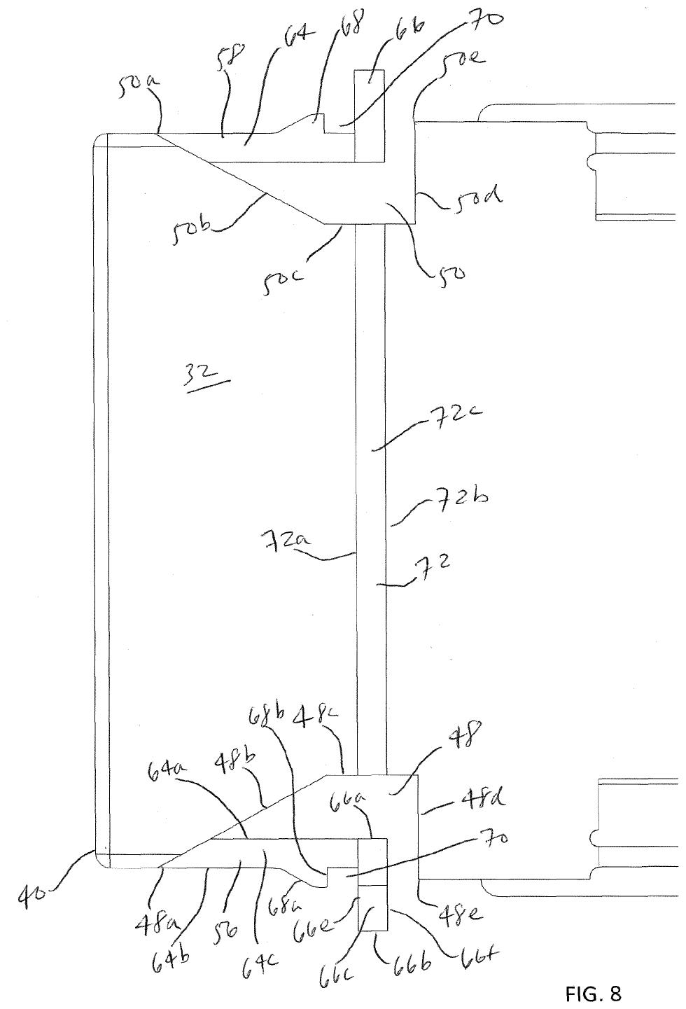

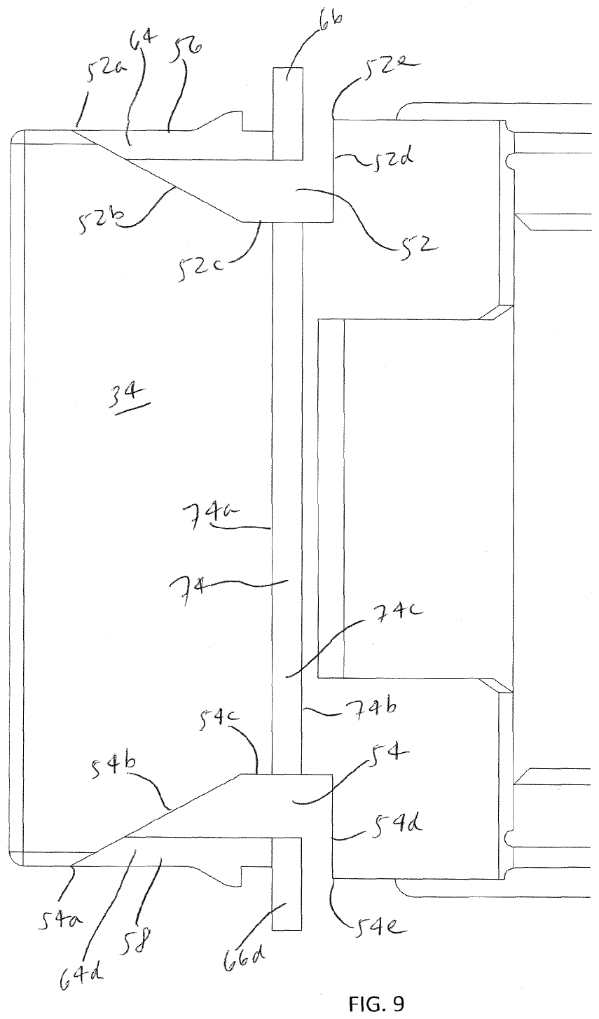

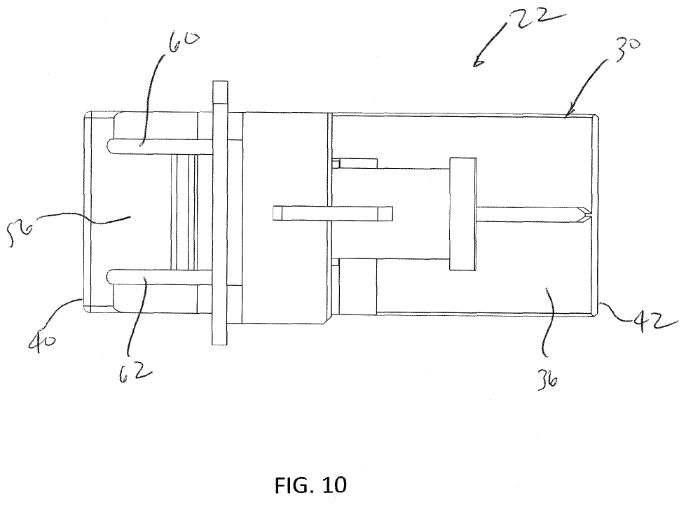

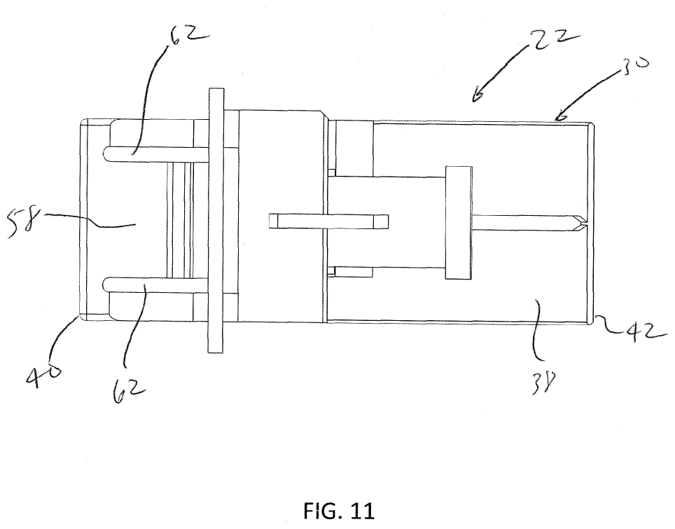

FIGS. 5-11 show a backplane connector according to an example implementation. The backplane 26 is planar and has opposite front and rear faces 26a, 26b which defines a thickness therebetween. The backplane 26 may be a planar circuit board. The sled 28 is planar and has opposite front and rear faces 28a, 28b which defines a thickness therebetween.

The backplane connector 22 includes a housing 30 formed of an insulative and dielectric material having opposing top and bottom walls 32, 34 which are interconnected by first and second side walls 36, 38 such that front and rear ends 40, 42 are defined. A plurality of passageways 44 extend through the housing 30 from the front end 40 to the rear end 42. Terminals (not shown) are mounted within the passageways 44 in a known manner. In an embodiment, the passageways 44 are formed as or generally formed as cylinders. In an embodiment, the terminals are optical fibers mounted in ferrules that are seated within the passageways. In an embodiment, the terminals are conductive pins seated within the passageways. A centerline 46 is defined through the passageway 44 and extends between the front and rear ends 40, 42. The centerline 46 defines a z-axis of the backplane connector 22. An x-axis, which is perpendicular to the z-axis, is defined along the width of the top wall 32, the width being defined between the side walls 36, 38. A y-axis, which is perpendicular to the z-axis and the x-axis, is defined along the height of the side wall 36, the height being defined between the top and bottom walls 32, 34.

The top wall 32 has a pair of cutouts therein 48, 50, each of which extends from the respective side wall 36, 38 and each of which is spaced longitudinally from the front end 40 of the housing 30. In an embodiment, each cutout 48, 50 has a front end 48a, 50a, a front wall surface 48b, 50b extending rearwardly from the front end 48a, 50a and at an angle relative to the centerline 46, an intermediate wall surface 48d, 50c extending rearwardly from the rear end of the front wall surface 48b, 50b and parallel to the centerline 46, and a rear wall surface 48d, 50d extending rearwardly from the intermediate wall surface 48b, 50b and perpendicular to the centerline 46 to a rear end 48e, 50e. The front ends 48a, 50a align with each other and the rear wall surfaces 48d, 50d align with each other.

The bottom wall 34 has a pair of cutouts therein 52, 54, each of which extends from the respective side wall 36, 38 and each of which is spaced longitudinally from the front end 40 of the housing 30. In an embodiment, each cutout 52, 54 has a front end 52a, 54a, a front wall surface 52b, 54b extending rearwardly from the front end 52a, 54a and at an angle relative to the centerline 46, an intermediate wall surface 52d, 54c extending rearwardly from the rear end of the front wall surface 52b, 54b and parallel to the centerline 46, and a rear wall surface 52d, 54d extending rearwardly from the intermediate wall surface 52b, 54b and perpendicular to the centerline 46 to a rear end 52e, 54e. The front ends 52a, 54a align with each other and the rear wall surfaces 52d, 54d align with each other.

A section of each side wall 36, 38 is formed as a latch arm 56, 58 which is partially separated from the remainder of the respective side wall 36, 38 by a cutout 60, 62 and can move relative to the remainder of the respective side wall 36, 38. Each latch arm 56 has a front end connected to the respective side wall 36, 38 proximate to the front ends 48a, 52a, 50a, 54a of the cutout 48, 52, 50, 54, an arm portion 64 extending from the front end to a head portion 66 at the rear end of the arm portion 64. Each arm portion 64 has an inner side surface 64a which faces the passageway 44, an opposite outer side surface 64b, a top surface 64c extending between the inner and outer side surfaces 64a, 64b and a bottom surface 64d extending between the inner and outer side surfaces 64a, 64b. A height of the arm portion 64 is defined between the top and bottom surfaces 64c, 64d. In an embodiment, the height of the arm portion 64 is less than the height of the respective side wall 32, 34. The head portion 66 is formed as a planar plate and extends outwardly from the outer surface 64b. The head portion 66 has an inner side surface 66a which faces the passageway 44 and may be coplanar with the inner side surface 64a of the arm portion 64, an opposite outer side surface 66b, and top, bottom, front and rear surfaces 66c, 66d, 66e, 66f extending between the inner and outer side surfaces 64a, 64b. The front surface 66e is planar. A height of each head portion 66 is defined between the top and bottom surfaces 66c, 66d, and in an embodiment, the height of each head portion 66 is greater than the height of the respective arm portion 64. A barb 68 extends outwardly from the outer surface 64b of the arm portion 64 and is spaced from the front surface 66e of the head portion 66 by a space 70. The barb 68 has a front surface 68a which curves outwardly from the outer surface 64b of the arm portion 64, and a rear face 68b which is perpendicular to the arm portion 64. The space 70 is formed by the rear face 68b of the barb 68, the outer surface 64b of the arm portion 64, and the front surface 66e of the head portion 66, and the space 70 defines a dimension which is the same as the thickness of the backplane 26.

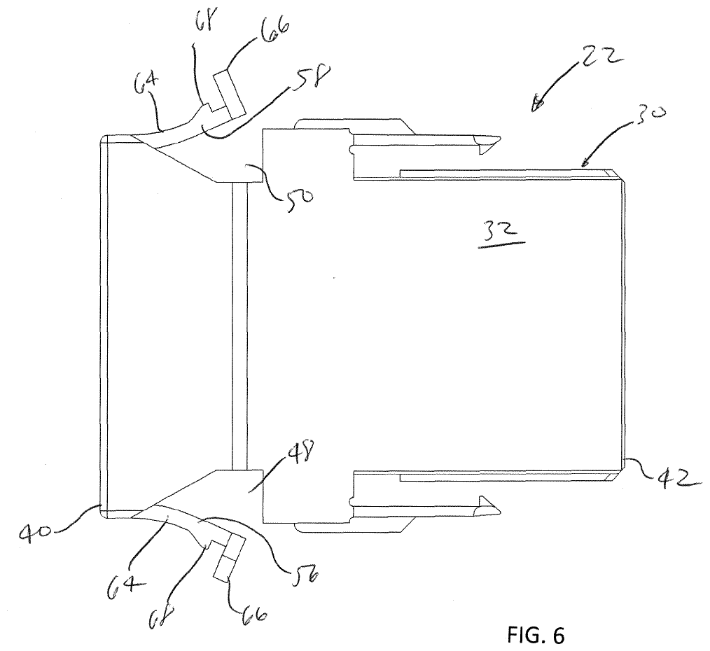

The latch arms 56, 58 can be moved relative to the respective side wall 36, 38 and relative to the top and bottom walls 32, 34. In a first position as shown in FIG. 6, the arm portions 64 curve outwardly from the respective side wall 36, 38. In a second position, the arm portions 64 are flexed to be parallel to the respective side wall 36, 38. In this second position, the arm portion 64 is parallel to the centerline 46, the head portion 66 is perpendicular to the arm portion 64, and the head portion 66 is proximate to the rear ends 48e, 52e, 50e, 54e of the cutouts 48, 52, 50, 54. In a third position, the arm portions 64 flex and the latch arms 56, 58 extend into the respective aligned cutouts 48, 52, 50, 54 in the top and bottom walls 32, 34.

The top wall 32 has a flange 72 extending along the width thereof between the cutouts 48, 60. The flange 72 has a planar front surface 72a, an opposite rear surface 72b, and a top surface 72c extending between the front and rear surfaces 72a, 72b. When the latch arms 56, 58 are in the second position, the flange 72 aligns with the head portions 66.

The bottom wall 34 has a flange 74 extending along the width thereof between the cutouts 52, 54. The flange 74 has a planar front surface 74a, an opposite rear surface 74b and a top surface 74c extending between the front and rear surfaces 74a, 74b. When the latch arms 56, 58 are in the second position, the flange 74 aligns with the head portions 66.

The backplane 28 is connected to the backplane connector 22 by inserting the backplane connector 22 through an aperture 76 in the backplane 26 which is sized to conform to the shape of a forward end portion 78 of the backplane connector 22 which is forward of the flanges 72, 74. As the backplane connector 22 is inserted through the aperture 76 in the backplane 26, the top and bottom edges of the aperture 76 slide along the top and bottom walls 32, 34, and the side edges of the aperture 76 slide along the side walls 36, 38. When the side edges of the aperture 76 contact the arm portions 64, the arm portions 64 flex inwardly into the passageway 44. When the side edges of the aperture 76 contact the curved surfaces 68a of the barbs 68, the arm portions 64 flex further inwardly into the passageway 44. After the side edges of the aperture 76 pass over the barbs 68, the backplane 26 seats within the spaces 70 such that the front surface 26a of the backplane 26 engages against the rear face 68b of the barb 68, and the rear surface 26b of the backplane 26 engages against the front face 66e of the head portion 66 of each latch arm 56, 58 and against the front face 72a, 74a of each flange 72a, 72b.

The backplane connector 22 and the backplane 26 can move relative to each along the x-axis. When the backplane connector 22 is moved in a first direction along the x-axis, the latch arm 56 flexes inwardly into the passageway 44 and the latch arm 58 flexes outwardly from the passageway 44. The cutouts 48, 52 allow the backplane 26 to move into the top and bottom walls 32, 34. Likewise, when the backplane connector 22 is moved in a second, opposite direction along the x-axis, the latch arm 58 flexes inwardly into the passageway 44 and the latch arm 56 flexes outwardly from the passageway 44. The cutouts 50, 54 allow the backplane 26 to move into the top and bottom walls 32, 34.

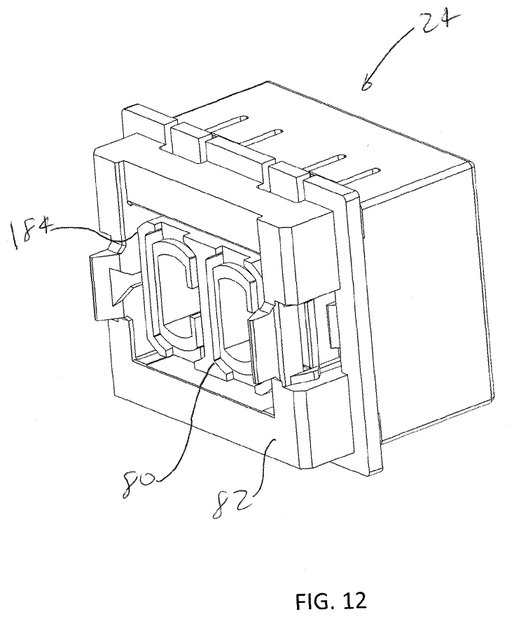

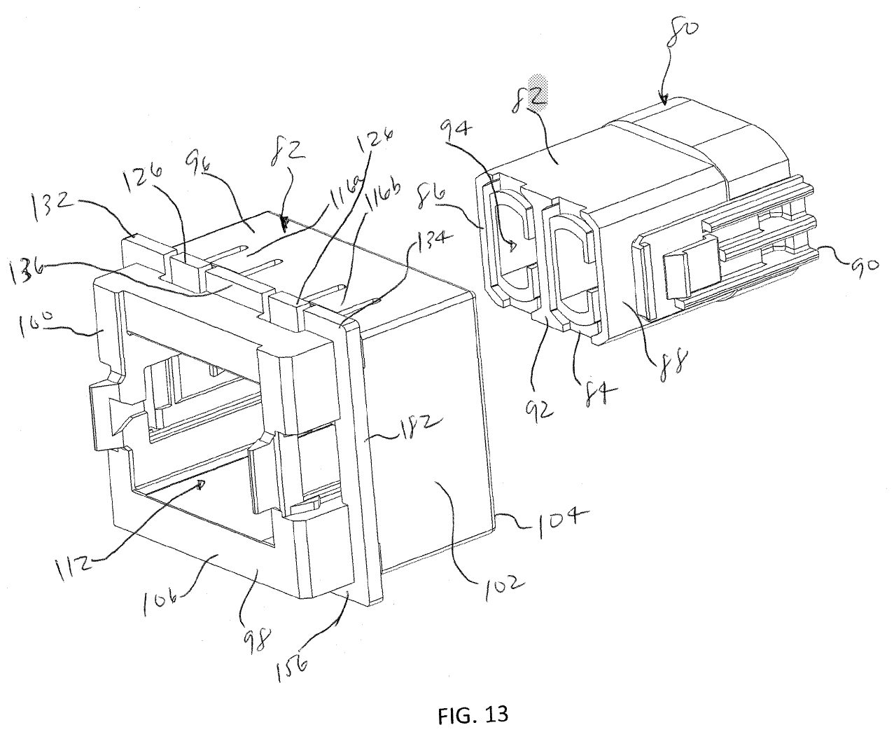

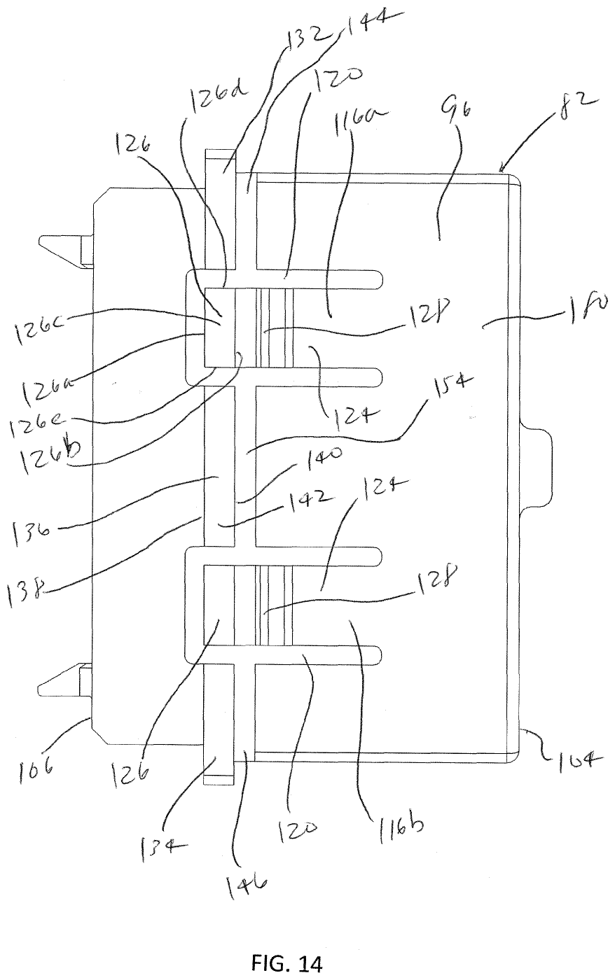

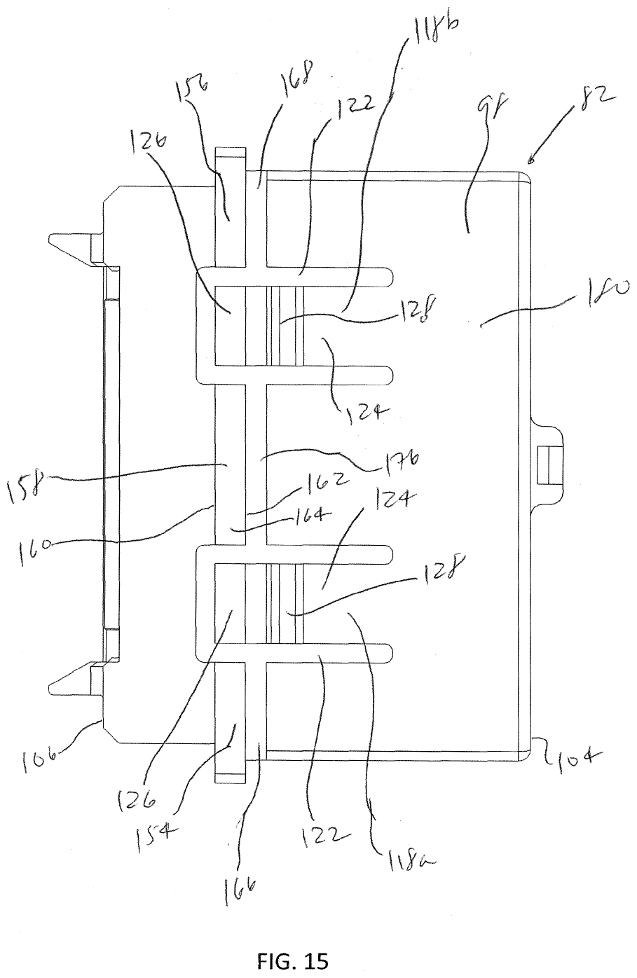

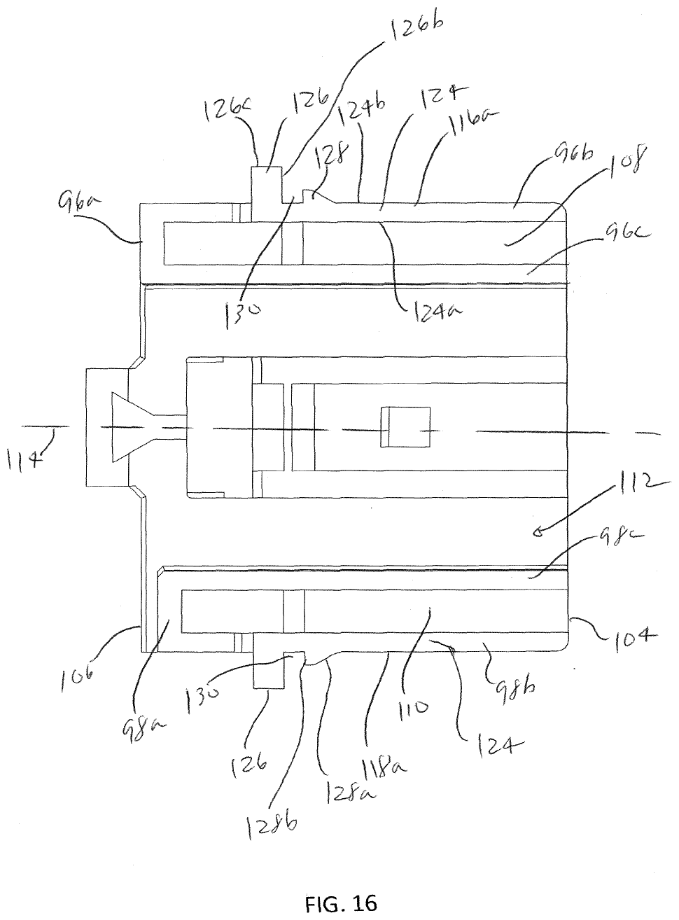

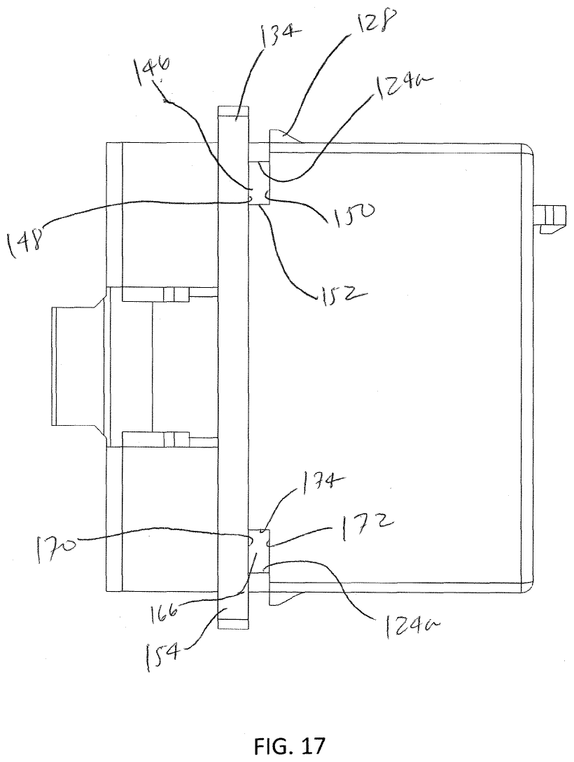

FIGS. 12-17 show a sled connector according to an example implementation. The sled connector 24 includes an inner housing 80 surrounded by an outer housing 82.

The inner housing 80 is formed of an insulative and dielectric material having opposing top and bottom walls 81, 84 which are interconnected by first and second side walls 86, 88 such that front and rear ends 90, 92 are defined. A plurality of passageways 94 extend through the inner housing 80 from the front end 90 to the rear end 92. Terminals (not shown) are mounted within the passageways 94 in a known manner. In an embodiment, the passageways 94 are formed as or generally formed as cylinders. In an embodiment, the terminals are optical fibers mounted in ferrules that are seated within the passageways. In an embodiment, the terminals are conductive pins seated within the passageways.

The outer housing 82 is formed of an insulative and dielectric material having opposing top and bottom walls 96, 98 which are interconnected by first and second side walls 100, 102 such that front and rear ends 104, 106 are defined. The top wall 96 has a vertical rear wall portion 96a, a top wall portion 96b which extends from an upper end of the rear wall portion 96a forwardly to the front end 104, and a bottom wall portion 96c which extends from a bottom end of the rear wall portion 96a forwardly to the front end 104. The top wall portion 96b and the bottom wall portion 96c are parallel to each other and are spaced apart from each other such that a top space 108 is formed therebetween. The bottom wall 98 has a vertical rear wall portion 98a, a bottom wall portion 98b which extends from a lower end of the rear wall portion 98a forwardly to the front end 104, and a top wall portion 98c which extends from a top end of the rear wall portion 98a forwardly to the front end 104. The bottom wall portion 98b and the top wall portion 98c are parallel to each other and are spaced apart from each other such that a bottom space 110 is formed therebetween. A central passageway 112 is defined by the wall portions 96c, 98c and the side walls 100, 102 and extends through the outer housing 82 from the front end 104 to the rear end 106. A centerline 114 is defined through the passageway 112 and extends between the front and rear ends 104, 106. The centerline 112 defines a z-axis of the backplane connector 22. An x-axis, which is perpendicular to the z-axis, is defined along the width of the top wall 96, the width being defined between the side walls 100, 102. A y-axis, which is perpendicular to the z-axis and the x-axis, is defined along the height of the side wall 102, the height being defined between the top and bottom walls 96, 98.

Sections of each wall portion 96b, 98b are formed as latch arms 116a, 116b, 118a, 118b which are partially separated from the remainder of the respective top wall portion 96b, 98b by cutouts 120, 122 and can move relative to the remainder of the respective wall portion 96b, 98b. The latch arms 116a, 116b are separated from each other; the latch arms 118a, 118b are separated from each other. Each latch arm 116a, 116b, 118a, 118b has a front end connected to the respective wall portion 96b, 98b, an arm portion 124 extending from the front end to a head portion 126 at the rear end of the arm portion 124. Each arm portion 124 has a surface 124a which faces the respective space 108, 110, a surface 124b opposite to the surface 124a, and side surfaces surface 124c, 126c extending between the surfaces 124a, 124b. The surface 124b of each latch arm 116a, 116b forms a top surface; the surface 124b of each latch arm 118a, 118b forms a bottom surface. A height of the arm portion 124 is defined between the surfaces 124a, 124b. The head portions 126 are formed as planar plates and extend outwardly from the surfaces 124b. Each head portion 126 has a rear surface 126a, a planar front surface 126b, and surfaces 126c, 126d, 126e, 126f extending between the inner and outer side surfaces 124a, 124b. The front surface 126e is planar. A height of each head portion 126 is defined between the surface 124b and surface 126c, and in an embodiment, the height of each head portion 126 is greater than the height of the respective arm portion 124. A barb 128 extends outwardly from the surface 124b of the arm portion 124 and is spaced from the front surface 126b of the head portion 126 by a space 130. The barb 128 has a front surface 128a which curves outwardly from the surface 124b of the arm portion 124, and a rear face 128b which is perpendicular to the arm portion 124. The space 130 is formed by the rear face 128b of the barb 128, the surface 124b of the arm portion 124, and the front surface 126b of the head portion 126, and the space 130 defines a dimension which is the same as the thickness of the sled 28.

The latch arms 116a, 116b, 118a, 118b can be moved relative to the respective wall portions 96b, 98b and relative to the side walls 100, 102. In a first position, the arm portions 124 are parallel to the respective wall portions 96b, 98b and the centerline 114, and the head portions 126 are perpendicular to the arm portions 124. In a second position, the arm portions 124 flex inwardly into the respective space 109, 110.

The top wall 96 has a first flange 132 extending along the x-axis between the side wall 100 and the latch arm 116a, a second flange 134 extending along the x-axis between the side wall 102 and the other latch arm 116b, and a third flange 136 extending along the x-axis between the latch arms 116a, 116b. The flanges 132, 134, 136 are aligned with each other and each flange 132, 134, 136 has a rear surface 138 which is spaced from the rear end 106 of the outer housing 82, a front surface 140 which is spaced from the front end 104 of the outer housing 82, and a top surface 142 which extends between the rear and front surfaces 136, 138. When the latch arms 116a, 116b are in the first position, the flanges 132, 134, 136 align with the head portions 126 such that the front surfaces 126b, 140 align with each other.

A first channel 144 is formed in the top wall 96 and the upper end of the side wall 100 forwardly of the flange 132 and extends along the x-axis between the side wall 100 and the latch arm 116a. A second channel 146 is formed in the top wall 96 and the upper end of the side wall 102 forwardly of the flange 134 and extends along the x-axis between the side wall 100 and the latch arm 116b. Each channel 144, 146 is formed by a rear wall 148 which extends downwardly from the respective flange 132, 134 into the space 108, a front wall 150 which extends downwardly from the top wall portion 96b into the space 108, and a bottom wall 152 extending between the lower ends of the rear and front walls 148, 150. When the latch arms 116a, 116b are in the first position, the bottom walls 152 are below the latch arms 116a, 116b. Each channel 144, 146 is sized to accommodate the sled 28 therein. A slot 154 is formed in top wall portion 96b and is in communication with the space 108. The slot 154 extends between the latch arms 116a, 116b. The slot 154 is sized to accommodate the sled 28 therethrough.

The bottom wall 98 has a first flange 154 extending along the x-axis between the side wall 100 and the latch arm 118a, a second flange 156 extending along the x-axis between the side wall 102 and the other latch arm 118b, and a third flange 158 extending along the x-axis between the latch arms 118a, 118b. The flanges 154, 156, 158 are aligned with each other and each flange 154, 156, 158 has a rear surface 160 which is spaced from the rear end 106 of the outer housing 82, a front surface 162 which is spaced from the front end 104 of the outer housing 82, and a top surface 164 which extends between the rear and front surfaces 160, 162. When the latch arms 118a, 118b are in the first position, the flanges 154, 156, 158 align with the head portions 126 such that the front surfaces 126b, 162 align with each other.

A first channel 166 is formed in the bottom wall 98 and the lower end of the side wall 102 forwardly of the flange 154 and extends along the x-axis between the side wall 102 and the latch arm 118a. A second channel 168 is formed in the bottom wall 98 and the lower end of the side wall 100 forwardly of the flange 156 and extends along the x-axis between the side wall 100 and the latch arm 118b. Each channel 166, 168 is formed by a rear wall 170 which extends upwardly from the respective flange 154, 156 into the space 110, a front wall 172 which extends upwardly from the bottom wall portion 98b into the space 110, and a top wall 174 extending between the upper ends of the rear and front walls 170, 172. When the latch arms 118a, 118b are in the first position, the top walls 174 are above the latch arms 118a, 118b. Each channel 166, 168 is sized to accommodate the sled 28 therein. A slot 176 is formed in bottom wall portion 98b and is in communication with the space 110. The slot 176 extends between the latch arms 118a, 118b. The slot 176 is sized to accommodate the sled 28 therethrough.

The flanges 132, 134, 136, 154, 156, 158 are aligned with each other along the z-axis.

The sled 28 is connected to the sled connector 24 by inserting the sled connector 24 through an aperture 178 in the sled 28 which is sized to conform to the shape of a forward end portion 180 of the sled connector 24 which is forward of the latch arms 116a, 116, 118a, 118b. As the sled connector 24 is inserted through the aperture 178 in the sled 28, the top and bottom edges of the aperture 178 slide along the top and bottom walls 96, 98, and the side edges of the aperture 178 slide along the side walls 100, 102. When the top and bottom edges of the aperture 178 contact the barbs 128 on the arm portions 124, the arm portions 124 flex inwardly into the respective spaces 108, 110. When the top and bottom edges of the aperture 178 contact the curved surfaces 128a of the barbs 128, the arm portions 124 flex inwardly into the respective spaces 108, 110. After the top and bottom edges of the aperture 176 pass over the barbs 128, the sled 28 seats within the spaces 130 such that the front surface 28a of the sled 28 engages against the rear faces 128b of the barbs 128, and the rear surface 28b of the sled 28 engages against the front surfaces 126b of the head portions 126 and the front faces 162 of the flanges 132, 134, 136, 154, 156, 158.

The sled connector 24 and the sled 28 can move relative to each along the y-axis. When the sled connector 24 is moved in a downward direction along the y-axis, the latch arms 116a, 116b flex inwardly into the top space 108 and the latch arms 118a, 118b flex outwardly from the bottom space 110. The sled 28 moves into the channels 144, 146 and through the slot 154 and into the top space 108. When the sled connector 24 is moved in an upward direction along the y-axis, the latch arms 1118a, 118b flexes inwardly into the bottom space 110 and the latch arms 116a, 116b flexes outwardly from the top space 108. The sled 28 moves into the channels 166, 168 and through the slot 176 into the bottom space 110.

Flanges 182 may extend outwardly from the side walls 100, 102 along the y-axis. The flanges 182 are aligned with the flanges 132, 134, 136, 154, 156, 158 along the z-axis.

The inner housing 80 seats within the passageway 112 of the outer housing 82 such that the rear end 92 of the inner housing 80 is forwardly of the rear end 106 of the outer housing 82 such that a pocket 184 is formed in the sled connector 24. The front end 90 of the inner housing 80 may extend from the front end 104 of the outer housing 82. The top wall 82 of the inner housing 80 and the top wall portion 96c of the outer housing 82 engage each other; the bottom wall 84 of the inner housing 80 and the bottom wall portion 98c of the outer housing 82 engage each other; the side wall 86 of the inner housing 80 and the side wall 100 of the outer housing 82 engage each other; and the side wall 88 of the inner housing 80 and the side wall 102 of the outer housing 82 engage each other. Mating features, such as latch arms which engage with openings, are provided on the inner and outer housings 80, 82 to retain the inner housing 80 within the outer housing 82.

The pocket 184 has the same dimensions as a rear end portion 186 of the backplane connector 22. When the backplane connector 22 and the sled connector 24 are plugged together, the rear end portion 186 of the backplane connector 22 seats within the pocket 184, and the terminals in the sled connector 24 interface with the terminals in the backplane connector 22. The top wall 32 of the backplane connector 22 and the top wall portion 96c of the outer housing 82 engage each other; the bottom wall 34 of the backplane connector 22 and the bottom wall portion 98c of the outer housing 82 engage each other; the side wall 36 of the backplane connector 22 and the side wall 102 of the outer housing 82 engage each other; and the side wall 38 of the backplane connector 22 and the side wall 100 of the outer housing 82 engage each other. Mating features, such as latch arms which engage with openings, are provided on the backplane connector 22 and the sled connector 24 to retain the engagement of the backplane connector 22 and the sled connector 24. In some embodiments, the outer housing 82 of the sled connector 24 and the backplane connector 22 include alignment features to assist in properly aligning the backplane connector 22 and the sled connector 24 during mating. In some embodiments, the alignment features are tabs which mate with protrusions.

Therefore, when the backplane connector 22 is mounted to the backplane 26, the sled connector 24 is mounted to the sled 28, and the backplane connector 22 and the sled connector 24 are mated together to form the backplane and sled connector assembly 20, the backplane and sled connector assembly 20 can move in the x-direction relative to the backplane 26 and can move in the y-direction relative to the sled 28. This allows for float movement between the backplane 26 and the sled 28 by the backplane and sled connector assembly 20.

In an embodiment, the mating features between the backplane connector 22 and the sled connector 24 allow for float movement in the z-direction when the backplane connector 22 is mounted to the backplane 26, the sled connector 24 is mounted to the sled 28, and the backplane connector and the sled connector 24 are mated together. In an embodiment, the mating features between the inner and outer housings 80, 82 of the sled connector 24 allow for float movement in the z-direction when the backplane connector 22 is mounted to the backplane 26, the sled connector 24 is mounted to the sled 28, and the backplane connector 22 and the sled connector 24 are mated together. In an embodiment, the mating features between the backplane connector 22 and the sled connector 24 and the mating features between the inner and outer housings 80, 82 of the sled connector 24 allow for float movement in the z-direction when the backplane connector 22 is mounted to the backplane 26, the sled connector 24 is mounted to the sled 28, and the backplane connector 22 and the sled connector 24 are mated together.

While a particular embodiment is illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

1. An assembly comprising:
a backplane connector comprising a backplane housing having a top wall, a bottom wall, a first side wall extending between the top and bottom walls, and a second side wall extending between the top and bottom walls, the backplane housing having at least one passageway extending between the front and rear ends thereof and having terminals mounted therein, at least one latch arm in the first side wall which is configured for movement relative to the first side wall, at least one latch arm in the second side wall which is configured for movement relative to the second side wall; and
a sled connector comprising a sled housing having a top wall, a bottom wall and side walls extending between the top and bottom walls, the sled housing having at least one passageway extending between the front and rear ends thereof and having terminals mounted therein, at least one latch arm in the top wall which is configured for movement relative to the top wall, at least one latch arm in the bottom wall which is configured for movement relative to the bottom wall, and
wherein when the backplane connector and the sled connector are mated together, the top walls are parallel to each other, the bottom walls are parallel to each other, the first side walls are parallel to each other, and the second side walls are parallel to each other.

2. The assembly of claim 1, wherein each latch arm has an arm portion extending from the respective wall and a head portion at a free end of the arm portion, and a barb extending from the arm portion and which is spaced from the head portion.

3. The assembly of claim 2, further including a backplane and a sled,
wherein the backplane mates with the backplane connector and engages with the latch arms thereof, the backplane seating between the barb and the head portion of the latch arms thereof, and
wherein the sled mates with the sled connector and engages with the latch arms thereof, the sled seating between the barb and the head portion of the latch arms thereof.

4. The assembly of claim 2,
wherein the backplane connector further comprises flanges extending outwardly from the top and bottom walls thereof, the flanges longitudinally aligning with the head portions of the backplane connector when the head portions of the backplane connector are in positions wherein the arms portions of the backplane connector are parallel to a centerline of the backplane connector, and
wherein the sled connector further comprises flanges extending outwardly from the top and bottom walls thereof, the flanges of the sled connector longitudinally aligning with the head portions of the sled connector when the head portions of the sled connector are in positions wherein the arms portions of the sled connector are parallel to a centerline of the sled connector.

5. The assembly of claim 4, wherein the sled connector further comprises flanges extending outwardly from the side walls thereof, the flanges extending from the side walls of the sled connector longitudinally aligning with the head portions of the sled connector when the head portions of the sled connector are in the positions wherein the arms portions of the sled connector are parallel to the centerline of the sled connector.

6. The assembly of claim 1, further including a backplane and a sled, wherein the backplane mates with the backplane connector and engages with the latch arms thereof, and wherein the sled mates with the sled connector and engages with the latch arms thereof.

7. The assembly of claim 6,
wherein the backplane connector further comprises flanges extending outwardly from the top and bottom walls thereof, the flanges longitudinally aligning with the head portions of the backplane connector when the head portions of the backplane connector are in positions wherein the arms portions of the backplane connector are parallel to a centerline of the backplane connector, and
wherein the sled connector further comprises flanges extending outwardly from the top and bottom walls thereof, the flanges of the sled connector longitudinally aligning with the head portions of the sled connector when the head portions of the sled connector are in positions wherein the arms portions of the sled connector are parallel to a centerline of the sled connector.

8. The assembly of claim 7, wherein the sled connector further comprises flanges extending outwardly from the side walls thereof, the flanges extending from the side walls of the sled connector longitudinally aligning with the head portions of the sled connector when the head portions of the sled connector are in the positions wherein the arms portions of the sled connector are parallel to the centerline of the sled connector.

9. The assembly of claim 1, wherein the backplane connector and the sled connector comprise mating features configured to couple the backplane connector and the sled connector together.
